(19) United States
(12) Patent Application Publication
(10) Pub. No.: US 2007/0246179 A1
(43) Pub. Date: Oct. 25, 2007

(54) Composites of Starch Containing Silicon, Method for the Production Thereof, and Use for Making Paper and Board

(75) Inventors: Petri Silenius, Lohja as (FI); Kimmo Koivunen, Espoo (FI); Hannu Alatalo, Lappeenranta (FI)

Correspondence Address: BIRCH STEWART KOLASCH & BIRCH, PO BOX 747, FALLS CHURCH, VA, 22040-0747, US

(73) Assignee: M-real Oyi, Espoo (FI)

(21) Appl. No.: 11/630,204

(22) PCT Filed: Jun. 15, 2005
(86) PCT No.: PCT/FI05/50213

§ 371 Date: Feb. 7, 2007

(30) Foreign Application Priority Data
Jun. 23, 2004 (FI) 20040866

(51) Int. Cl. D21H 17/70; C08L 3/02

(52) U.S. Cl. 162/146; 106/212.1; 252/182.12; 427/445

(57) ABSTRACT

The invention relates to composites of starch containing silicon, particularly to starch silica, and starch silicate composites, a method for the production thereof and the use thereof as a filler in paper and board and as a coating pigment.

### FIELD OF THE INVENTION

The present invention relates to composites of starch containing silicon, particularly starch silica, and starch silicate composites, a method for the production thereof and the use thereof as a filler in paper and board and as a coating pigment. Moreover, the invention is directed to a method for producing paper and board, and a method for coating paper.

### PRIOR ART

Traditionally, both mineral and synthetic fillers are used in the production of paper and board to improve optical properties such as the light scattering coefficient thereof. In the production of paper and board, finely dispersed mineral pigments such as kaolin, clay, ground or precipitated calcium carbonate, titane dioxide, or precipitated silicates are added to the pulp for improving the opacity and other optical properties. With increasing proportions of the mineral pigments, the optical properties are normally improved, whereas, however, strength properties decline. Also dry strength additives such as carboxymethyl cellulose and synthetic polymers including PAM, PVA, and latex are used in the field. The use thereof in higher concentrations causes operational problems, thus limiting the applicability thereof.

In the production of paper and board, starch is typically added to the pulp as an aqueous solution primarily to improve the strength properties of the product. The use of starch in high amounts is, however, not possible due to operational problems and cost.

The strength properties of paper may also be improved by beating of the pulp and addition of fines, which, however, often result to a decreased opacity. Moreover, dewatering may be a problem in both cases.

WO 99/16972 discloses the use of alkali metal silicates, particularly sodium silicate in combination with starch to improve the strength of paper and board. Both the silicate and the starch are added in a finely dispersed form to the fibre suspension at the wet end prior to web formation. The starch is uncooked and the alkali silicate is selected from silicates insoluble in water at the temperatures of the wet end, the silicates being soluble only at temperatures encountered in the drying section.

GB 2 223 038 presents a composition for the production of paper and board comprising starch particles insoluble in water at temperatures below 35° C., in an aqueous solution with a flocculating agent, preferably a polyacrylamide, and filler particles. Conventional mineral fillers such as calcium carbonate are mentioned as suitable fillers. With this composition, higher amounts of filler may be incorporated into paper, thus improving the brightness and opacity thereof for a given strength level.

U.S. Pat. No. 6,623,555 describes a method for preparing a composite pigment from precipitated calcium carbonate (PCC), and silicate. The composite pigment is produced by introducing a soluble silicate compound to an aqueous medium containing precipitated calcium carbonate obtained by carbonation of lime milk. An insoluble silicon compound is precipitated on the calcium carbonate thus formed by carbonating the reaction mixture, that is, by bubbling CO₂ through the reaction mixture.

Optical properties including e.g. opacity and light scattering coefficient, and bonding strength often called as the Scott Bond value are some of the most important characteristics of printing papers. Generally for boards and papers, and especially for graphic papers, there is a need for simultaneous improvement of the optical and strength properties.

Incineration of waste papers containing inorganic mineral pigments for energy production results in high amounts of ash, the disposal of which causes problems. Within the European Union, goals concerning the proportion of bioenergy in the total energy production to be attained until 2010 are set. To attain the goals, it is also desirable to use renewable organic materials as much as possible in paper and board.

On the basis of what is said above, there is an obvious need for a novel filler and a coating pigment for papers and boards allowing the simultaneous improvement of the optical and strength properties thereof and allowing the increase of the proportion of renewable and compustible organic materials in papers and boards.

### OBJECTS OF THE INVENTION

An object of the invention is to provide novel composites of starch containing silicon, particularly starch silica, and starch silicate composites.

Another object of the invention is to provide a method for producing composites of starch containing silicon, particularly starch silica, and starch silicate composites.

Further, another object of the invention is the use of composites of starch containing silicon, particularly starch silica, and starch silicate composites as a filler in paper and board, and as a coating pigment in the production of paper and board.

Still another object of the invention is to provide a method for producing paper and board.

Moreover, another object of the invention is to provide a method for coating paper and board.

Characteristic features of the composites of starch containing silicon, particularly starch silica, and starch silicate composites according to the invention, the method for the production thereof, the use thereof, the method for the coating of paper and board, and the method for the production of paper and board are presented in the appended claims.

### SUMMARY OF THE INVENTION

The invention is directed to composites of starch containing silicon, particularly starch silica, and starch silicate composites comprising starch and silica and/or silicate. The starch silica and starch silicate composites of the invention may be produced by precipitating silica and/or silicates on the starch. The starch silica, and starch silicate composites thus obtained may be used as a filler in paper and board for simultaneous improvement of the optical and strength properties of the product in comparison to conventional fillers. Further, the composite of the invention may be used as a coating pigment of paper and board.

### DETAILED DESCRIPTION OF THE INVENTION

It has been surprisingly found that the problems associated with the solutions of the prior art may be avoided or at least substantially reduced by the procedure of the invention. The invention is based on the fact that silica and/or silicate may be precipitated on starch resulting in starch silica and/or starch silicate composites suitable for the production of paper and board both as a coating pigment, and a filler.

The starch to be used in the composite of the invention is vegetable starch such as barley, oat, rice, or corn starch or a mixture thereof. The gelatinization temperature of the starch is at least 50° C. The starch is selected from the group consisting of native starch, anionic starch, cationic starch and the mixtures thereof, the starch preferably being anionic starch. The starch preferably consists of granular particles, the mean particle size of the grains typically varying between 3 and 20 μm.

The silicate is selected from the group consisting of metal silicates such as alkaline earth metal silicates, alkali metal silicates, alkaline earth metal and alkali metal aluminium silicates, and modifications thereof including mixed salts with alkaline earth metal salts and hydroxides, and further, mixed salts and combinations of the above compounds. The silicate is preferably calcium silicate, magnesium silicate, sodium aluminium silicate, sodium magnesium silicate, sodium silicate or aluminium silicate, particularly preferably sodium aluminium silicate.

The silica is selected from the group consisting of precipitated silicon dioxides.

According to the invention, also a combination of silica and silicates may be used.

The composite of the invention contains from 10 to 95% by weight, preferably from 50 to 80% by weight of silica and/or silicate.

In the method for producing starch silica and/or starch silicate composites of the invention, silica and/or silicate is precipitated on starch particles. To this end, a silicon compound is allowed to react with a suitable precipitating compound and allowed to precipitate on the starch particles.

Precipitation of Silica

Silicon dioxide or silica (SiO₂) may for instance be precipitated according to the reaction equation (1) below. A suitable silicon compound, that is a basic metal silicate and an aqueous solution of an exemplary sodium silicate (water glass) are reacted with a precipitating compound, in this case with a mineral acid, typically H₂SO₄.
[Na₂O:xSiO₂]+H₂SO₄→xSiO₂+Na₂SO₄+H₂O (1)

Precipitated silica is also obtained by reacting alkali metal silicate with sulphurous acid or with sulphur dioxide. In addition, an aqueous solution of alkali metal sulfite or bisulfite is formed.

Precipitation of Silicates

Synthetic silicates are obtained by reacting a silicon compound with a precipitating compound. The precipitating compound may also be formed in situ during the reaction. This results is silicates such as sodium aluminium silicate, calcium silicate and aluminium silicate. Of these, particularly sodium aluminium silicate is most commonly used in papermaking.

Suitable silicon compounds include precipitated silicas, metal silicas such as alkaline earth metal silicates and alkali metal silicates, alkaline earth and alkali metal aluminium silicates and modifications thereof including mixed salts with alkaline earth metal salts and hydroxides, and further, mixed salts and combinations of the above compounds.

Silicate, for instance sodium aluminium silicate, may be precipitated according to the reaction equation (2) below. Aluminium sulphate, or alum, reacts with an aqueous solution of sodium silicate.
[Na₂O:xSiO₂]+Al₂(SO₄)₃→Na₂O.Al₂O₃.4[xSiO₂].4-6H₂O+Na₂SO₄ (2)

Alternatively, an alkali metal silicate may be reacted using an aqueous solution of aluminium sulfite resulting in precipitated alkali metal aluminium silicate and an aqueous phase containing alkali metal sulfite, or bisulfite according to the pH value of the final stage of the reaction.

Precipitated alkali metal aluminium silicate is also obtained by treating a solution of alkali metal silicate with an alkali metal aluminate in the presence of sulphur dioxide, a solution of sulphurous acid, or a solution of sulphuric acid. Moreover, an aqueous phase containing alkali metal sulfite is obtained. In this case, the precipitating aluminium sulfite reagent is formed in situ during the reaction.

Zinc silicate may be precipitated by mixing a solution of sodium silicate and a solution of zinc chloride together by substituting a sulphuric acid solution for the zinc chloride solution in the final stage of the reaction.

In the method of the invention, a suspension containing starch is added to an aqueous solution containing a precipitating compound and optionally another salt may be added as an adjuvant, followed by the addition of an aqueous solution of a silicon compound and optionally an aqueous solution of the precipitating compound or an aqueous solution of a mineral acid to the mixture, and then the pH of the slurry thus prepared is adjusted to be 7 or below, if necessary.

For precipitation of silicas, the precipitating compound is selected from the group consisting of inorganic acids and sulphur dioxide, preferably sulphuric acid, sulphurous acid and sulphur dioxide.

For precipitation of silicates, the precipitating compound is selected from the group consisting of inorganic acids and alkaline earth metals, alkali metals, earth metals, salts of zinc and aluminium, preferably sulfate, sulfite, nitrate and ammoniumsulfate salts. Particularly preferably, the precipitation is carried out using aluminium sulfate, aluminium sulfite or alkali metal aluminate in the presence of sulphur dioxide, sulphurous acid or sulphuric acid. Alternatively, the precipitation may also be carried out using zinc chloride, sulphuric acid solution being substituted for said zinc chloride in the final stage of the reaction.

The salt to be used as the adjuvant is selected from the group consisting of alkaline earth metal salts and hydroxides. Suitable salts include chlorides, sulfates and carbonates of the alkaline earth metals such as magnesium and calcium. Magnesium hydroxide is preferably used.

For precipitation of silicates, the silicon compound is selected from the group consisting of precipitated silicas, alkali metal and alkaline earth metal silicates, alkali metal and alkaline earth metal aluminium silicate, and modifications thereof including mixed salts with alkaline earth metal salts and hydroxides, and further, mixed salts and combinations of the above compounds.

For precipitation of silicas, the silicon compound is selected from the group consisting of alkali metal and alkaline earth metal silicates.

In the method of the invention, an aqueous solution of the precipitating compound with pH typically in the acidic range is prepared, followed by the addition of the suspension of the dispersed starch thereto. Finally, an aqueous solution of the compound to be precipitated and an aqueous solution of the precipitating compound and/or acid to adjust the pH of the reaction mixture at 7 or below, preferably to be in the range of 4-7, are added simultaneously.

In a preferable embodiment of the invention, the precipitating compound (aluminium sulfate Al₂(SO₄)₃×14.3H₂O)) is dissolved in an excessive amount of water having a temperature ranging between 10 and 90° C., preferably between 30 and 60° C. Then, granular starch dispersed in an excessive amount of water is added to the solution. A salt, preferably magnesium hydroxide may be optionally added as an adjuvant to the suspension thus prepared for improving the precipitation, followed by agitation of the mixture at a temperature ranging between 10 and 90° C.

A compound to be precipitated (metal silicate, in the present case, sodium silicate (Na₄SiO₄)) and an aqueous solution of the precipitating compound (aluminium sulfate) are then added to the suspension. The desired silicon compound (sodium aluminium silicate) then precipitates on said starch granules resulting in a suspension containing the starch silicate composite. The viscosity of the suspension is suitably adjusted by adding water. The pH value of the suspension is adjusted to be 7 or below, preferably from 4 to 6, by the precipitating compound (aluminium sulfate). The suspension may be used as such without further treatment/filtration/drying, and optionally, it may also be filtrated, washed and dried. If necessary, the particle size may be optimized e.g. by grinding. If desired, adjuvants such as dispersing agents may be added to the suspension.

The starch composite containing silicon according to the invention, particularly starch silica and/or starch silicate composite may be used as a filler in paper and board. The composite of the invention is a suitable filler both for fine papers and papers containing mechanical pulp, for instance for LWC, MWC, and SC.

The starch silica and/or starch silicate composites of the invention may also be used as coating pigments for papers containing mechanical pulp, for instance for LWC printing papers, and further as coating pigments for boards, for instance for FBB board.

In the method of the invention for producing paper or board, the starch silica and/or starch silicate composite is added to the pulp during the paper and board production at a suitable point of the system upsteam of the press section, preferably in the short circulation and particularly preferably at the proximity of the head box such as on the suction side of the mixing pump, or at the proximity of the feed pump of the head box to obtain a filler content in the paper and board, that is the amount of starch silica and/or starch silicate composite in the paper or board, ranging between 1 and 50% by weight, followed by finishing the paper or board production in a conventional manner. The starch will then gelatinize at the temperatures encountered in the drying section, thus binding the silica/silicate particles to the paper or board. Drying may be carried out conventionally as contact drying, that is cylinder drying, the surface temperature of the cylinder being typically from 100 to 160° C., but the drying may, however, be carried out using any other drying method.

In the method of the invention for coating papers, the starch silica and/or starch silicate composites are applicated as such in the form of the above suspension or as a mixture with known binders such as starch or latex, thickeners such as carboxymethyl cellulose or other additives used in coating pigments to obtain a proportion of the pigment in the coating paste typically ranging between 80 and 95% by weight. Application on the paper or board web may be carried out with any known coating method.

The starch silica and starch silicate composites of the invention are associated with several advantages in comparison to known fillers and coating pigments of the prior art. Simultaneously, the critical balance of properties of paper and board, particularly optical properties such as light scattering coefficients and strength properties such as bonding strengths and tensile index values may be favourably influenced by the composite. In addition, grammage of paper and board may be reduced by using the composite. The viscosity of the suspension containing starch particles is lower that that of the cooked starch. With the starch composite of the invention, is possible to reduce the dosage of the pulp starch typically used as a dry strength additive. Thus advantages with respect to the balance of strength and dewatering properties may also be reached.

With the composite of the invention, it is possible to increase the proportion of renewable organic materials in papers and boards, and improve the utilization by combustion of papers and boards that will no longer be recycled. Within the EU, the disposal of compostable material to landfills will be prohibited in the future, and accordingly, combustion will be an important alternative for waste disposal.

The invention will now be illustrated by the following examples without wishing to limit the scope thereof with these examples.

### EXAMPLES

### Example 1

Preparation of the Starch Silicate Composite

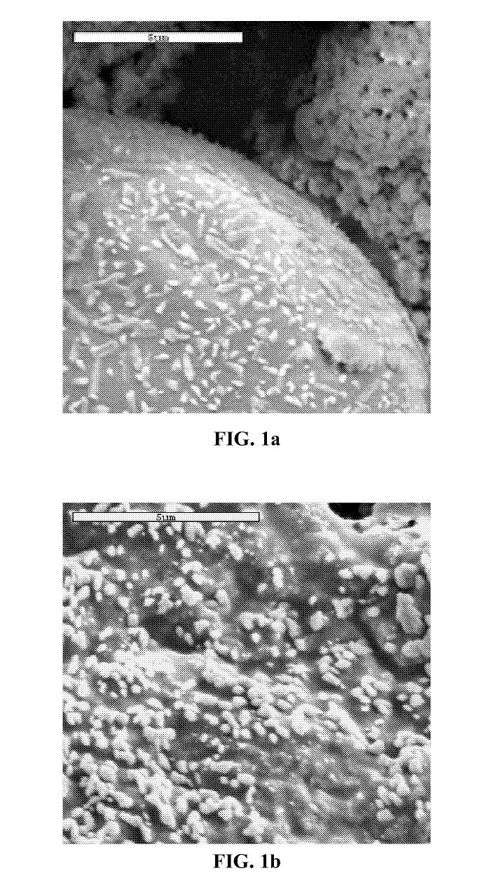

The starch silicate composite was prepared in laboratory scale by precipitating silicate on starch grains in a 4 1 crystallization container. The temperatures of the reagents were equalized prior to addition, the pH of the reaction mixture being measured during the reaction. 6.6 g of aluminium sulfate, and 1000 g of deionized water, 31 g of anionic starch grains dispersed in 150 g of deionized water, and further, 1.1 g of magnesium hydroxide were added into the crystallization container. The mixture was mixed at 40° C. Then, 414 g of sodium silicate and 67.4 g of aluminium sulfate dissolved in 388.6 g of deionized water were simultaneously added to the mixture during 5 minutes at the initial temperature of 40° C., followed by agitating the mixture at 40° C. During the reaction, pH was adjusted to the value of 7 or below to avoid gelling. Precipitated sodium aluminium silicate was filtered. The SEM image of the sodium aluminium silicate starch composite thus prepared is presented in the appended FIGS. 1a and 1b clearly showing the silicate particles precipitated on the starch grains. The particle size of the composite was determined by laser diffraction method. Mean particle size was about 30 μm, the size ranging between 2 and 300 μm, including the agglomerated particles. The composite contained 80% by weight of sodium aluminium silicate and 20% by weight of starch.

### Example 2

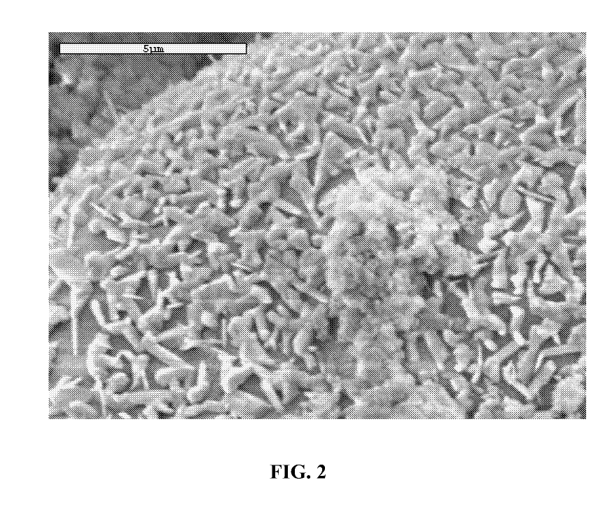

Sodium aluminium starch composite was prepared as in Example 1, using native granular starch. The SEM image of the resulting composite is presented in the appended FIG. 2.

### Example 3

Use of the Starch Silicate Composite as a Filler in Paper

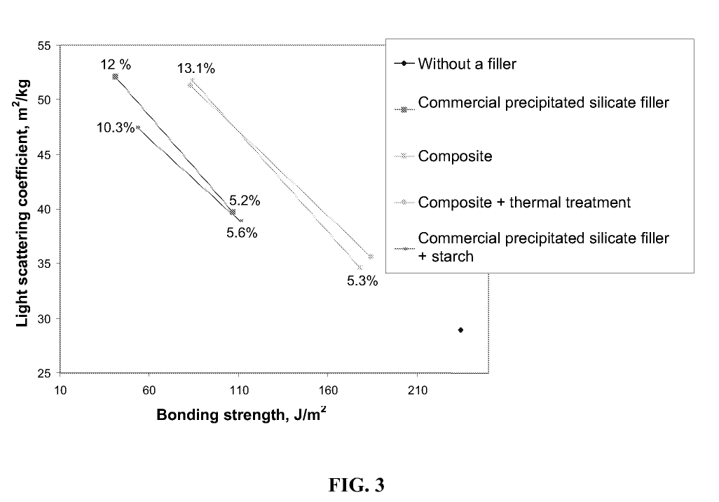

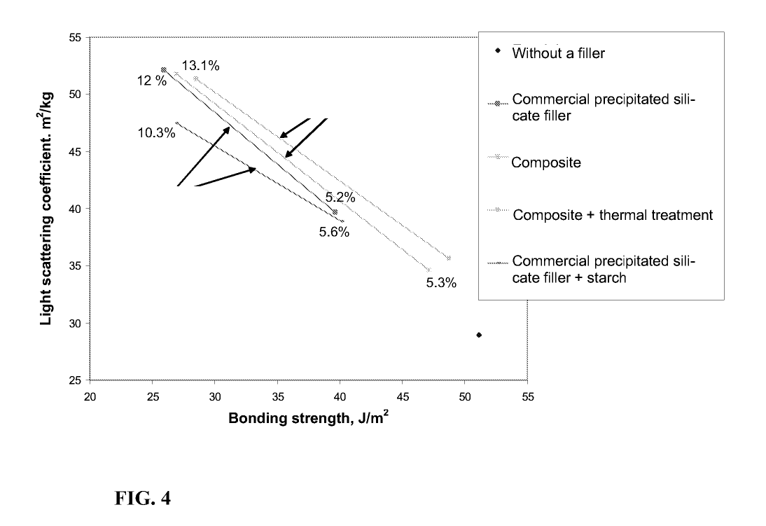

Sheets were made from pulp containing 70% of bleached birch pulp and 30% of bleached softwood pulp, said sheets containing 1) composite filler of the invention prepared from anionic starch, or 2) composite filler of the invention prepared from anionic starch, the sheets being further thermally treated. Sheets 3) without a filler, and sheets 4) containing a commercial precipitated silicate as the filler were used as controls, respectively. Sheets having a grammage of 60 g/m² were prepared according to the standard SCAN C 26:76. The contents of the mineral filler in the control sheets were 6% and 14% by weight. For the composite fillers, total filler contents were 7.5% and 17.5%, by weight. Some sheets (2) were thermally treated at 90° C. for 10 minutes prior to drying thereof under conventional conditions. Light scattering coefficients, bonding strengths as Scott Bond values, and tensile index values were determined using the methods of SCAN-P 8:93, TAPPI T 569 and SCAN-P 67:93. FIG. 3 graphically shows the light scattering coefficient as a function of the bonding strength. The Figure clearly shows that by using the composite fillers of the invention, both the light scattering coefficient and the bonding strength may be simultaneously improved. FIG. 4 shows the light scattering coefficient as a function of the tensile index. From this, it may be seen that both the tensile index and the light scattering coefficient may be simultaneously improved.

1. Composite of starch containing silicon, characterized in that the composite comprises starch particles having silica and/or silicate precipitated thereon.

2. Composite according to claim 1, characterized in that the starch is granular starch and it is anionic or native or cationic, preferably anionic.

3. Composite according to claim 1, characterized in that the silicate is selected from the group consisting of alkaline earth metal silicates, alkali metal silicates, alkaline earth metal aluminium silicates, alkali metal aluminium silicates, modifications thereof, mixed salts and combinations of the above compounds, and the silica is selected from the group consisting of precipitated silicon dioxides.

4. Composite according to claim 1, characterized in that the composite contains silica and/or silicate from 10 to 95%, preferably from 50 to 80%, by weight.

5. Method for producing a composite of starch containing silicon, characterized in that a suspension containing starch and optionally an adjuvant salt is added to an aqueous solution containing a precipitating compound, followed by the addition of an aqueous solution of a silicon compound and optionally an aqueous solution of the precipitating compound and/or an acid to the thus obtained mixture, the pH of the slurry thus prepared being then adjusted to be 7 or below, if necessary.

6. Method according to claim 5, characterized in that the precipitating compound is selected from the group consisting of inorganic acids and sulphur dioxide for precipitation of silicas, and from the group consisting of inorganic acids and alkaline earth metals, alkali metals, earth metals, and sulfate, sulfite, nitrate, and salts of zinc and aluminium, and ammonium sulfate salts for precipitation of silicates.

7. Method according to claim 5, characterized in that for precipitating silicates, the silicon compound is selected from the group consisting of precipitated silicas, alkali metal and alkaline earth metal silicates, alkali metal and alkaline earth metal aluminium silicates, and calcium carbonate and magnesium carbonate of the said mixed salts, and said combinations; and alkali metal and alkaline earth metal silicates for precipitating silica.

8. Method according to claim 5, characterized in that the adjuvant salt is selected from the group consisting of salts and hydroxides of alkaline earth metals, preferably chlorides, sulfates, carbonates, and hydroxides of magnesium and calcium.

9. Method according to claim 5, characterized in that the starch is granular starch and it is anionic or native or cationic, preferably anionic.

10. Use of a composite of starch containing silicon according to any one of claims 1-4 or manufactured according to claim 5 as a filler in paper or board.

11. Use of a composite of starch containing silicon according to claim 1 or manufactured as a coating pigment of paper and board.

12. Method for producing paper or board, characterized in that a composite of starch containing silicon according to claim 1 or manufactured is added to pulp followed by conventional production of the paper.

13. Method for coating paper or board, characterized in that a composite of starch containing silicon according to claim 1 or manufactured is applicated as a suspension or mixed with adjuvants of the coating, by a known method on a paper or board web.

14. Composite according to claim 2, characterized in that the silicate is selected from the group consisting of alkaline earth metal silicates, alkali metal silicates, alkaline earth metal aluminium silicates, alkali metal aluminium silicates, modifications thereof, mixed salts and combinations of the above compounds, and the silica is selected from the group consisting of precipitated silicon dioxides.

15. Composite according to claim 2, characterized in that the composite contains silica and/or silicate from 10 to 95%, preferably from 50 to 80%, by weight.

16. Composite according to claim 3, characterized in that the composite contains silica and/or silicate from 10 to 95%, preferably from 50 to 80%, by weight.

17. Method according to claim 6, characterized in that for precipitating silicates, the silicon compound is selected from the group consisting of precipitated silicas, alkali metal and alkaline earth metal silicates, alkali metal and alkaline earth metal aluminium silicates, and calcium carbonate and magnesium carbonate of the said mixed salts, and said combinations; and alkali metal and alkaline earth metal silicates for precipitating silica.

18. Method according to claim 6, characterized in that the adjuvant salt is selected from the group consisting of salts and hydroxides of alkaline earth metals, preferably chlorides, sulfates, carbonates, and hydroxides of magnesium and calcium.

19. Method according to claim 7, characterized in that the adjuvant salt is selected from the group consisting of salts and hydroxides of alkaline earth metals, preferably chlorides, sulfates, carbonates, and hydroxides of magnesium and calcium.

20. Method according to claim 6, characterized in that the starch is granular starch and it is anionic or native or cationic, preferably anionic.
